(19) United States
(12) Patent Application Publication
(10) Pub. No.: US 2022/0067629 A1
(43) Pub. Date: Mar. 3, 2022

(54) MANPOWER MANAGEMENT SYSTEM

(71) Applicant: Vingroup Joint Stock Company, Ha Noi City (VN)

(72) Inventors: Quang Huy NGUYEN, Ha Noi City (VN); William Quy LEE, Ha Noi City (VN); Giang Truong NGUYEN, Ha Noi City (VN); Quang Ngoc KHUAT, Ha Noi City (VN); Duy Hung NGUYEN, Ha Noi City (VN); Khac Linh TRINH, Ha Noi City (VN); Hoai Nam NGUYEN, Ha Noi City (VN)

(21) Appl. No.: 17/394,806

(22) Filed: Aug. 5, 2021

(30) Foreign Application Priority Data
Aug. 26, 2020 (VN) 1-2020-04931

(51) Int. Cl. G06Q 10/06; G06K 9/00; G06K 9/62

(52) U.S. Cl. CPC G06Q 10/06398; G06K 9/6256; G06K 9/00335; G06Q 10/06393

(57) ABSTRACT

Provided is a manpower management system comprising a data communication unit configured to receive motion signals from a wearable unit worn by a specific employee to sense motions of the specific employee; a data processing unit configured to label the motion signals with behavior data to generate a labeled training dataset for the specific employee; a deep learning model for the specific employee configured to be trained through machine learning using the labeled training dataset, a recognition unit configured to recognize behavior of the specific employee in response to an input of a motion signal of the specific employee received by the data communication unit, using the trained deep learning model, and output a behavior data of the specific employee; and a simulation unit configured to evaluate employee's work efficiency using the output behavior data.

### CROSS-REFERENCE TO RELATED APPLICATIONS

This application claims priority to Vietnamese Application No. 1-2020-04931 filed on Aug. 26, 2020. The aforementioned application is incorporated herein by reference in its entirety.

### TECHNICAL FIELD

Embodiments of the present invention relate to a manpower management system, and more particularly, to a manpower management system applicable to manpower management for company, school, organization, and the like.

### RELATED ART

Although various factors are required to perform efficient work, the most important factor has been recognized as human resources along with the development of modern society. In particular, it is becoming more important than anything else to put necessary manpower at the right place and right time to utilize competent human resources.

Currently, solutions to the employee management problem are mainly based on experiences of managers, as well as extensive researches in many different careers, with a wish that the work performance data will assist in recognizing a pattern showing the efficiency of employee management solutions. These experiences and researches are not perfect and could be counter-productive if the person applying the pattern does not have an insight about both the method and the environment to be applied. Therefore, there is a need for a solution to the employee management problems specific for each company with new type of data and analytical method, using a reliable technology for data collection.

Recently, many researches on action recognition models, including action recognition models using motion sensor data have been conducted. The latest researches have gained good results on open source datasets. However, when applied in practice, they cannot achieve a high accuracy. This is because the action data included in the open source datasets is of simple actions; the requirements for dataset labeling are not strict; and the labeling and the label identifying are directed to apply in research rather than in practice.

Further, recently, various types of personnel management systems have been introduced so that personnel management can be considered from an integrated perspective.

For example, a method of maximizing work efficiency through work management and human resource management for an organization and effectively using and managing the human resources of the organization through a communication network, a method of securing the transparency of an organization and objectively evaluating the level of human resources in the organization through the objective evaluation for the organization, and the like have been tried.

However, there is a problem in that it is difficult to reflect the work characteristics and behavior characteristics of each employee. If these factors can be exploited, they can potentially increase work efficiency of individual employees and increase earning of a company.

### SUMMARY

In order to overcome the above-mentioned shortcomings, the present invention is directed to providing a manpower management system capable of improving the work efficiency of employees.

The present invention is also directed to providing a manpower management system capable of providing guidelines for manpower arrangement in companies, schools, organizations, etc.

According to an aspect of the present invention, there is provided a manpower management system comprising a data communication unit configured to receive motion signals from a wearable unit worn by a specific employee to sense motions of the specific employee; a data processing unit configured to label the motion signals with behavior data to generate a labeled training dataset for the specific employee; a deep learning model for the specific employee configured to be trained through machine learning using the labeled training dataset, a recognition unit configured to recognize behavior of the specific employee in response to an input of a motion signal of the specific employee received by the data communication unit, using the trained deep learning model, and output a behavior data of the specific employee; and a simulation unit configured to evaluate employee's work efficiency using the output behavior data.

The simulation unit is further configured to simulate efficiency for a work solution for the specific employee using the output behavior data.

The simulation unit is configured to provide a work solution with optimal efficiency for the specific employee based on a result of the simulation.

The output behavior data includes data on daily behavior, work execution time, and processing time for other works.

The recognition unit configured to perform calculations to compare the input motion signal with a previously trained data to decide the behavior data of the specific employee.

The motion signal is collected within a predetermined period of time that varies depending on each company, department, and employee.

The motion signal has a collection cycle set differently for each employee.

According to another aspect of the present invention, there is provided a manpower management method comprising receiving motion signals from a wearable unit worn by a specific employee to sense motions of the specific employee; labeling the motion signals with behavior data to generate a labeled training dataset for the specific employee; training a deep learning model for the employee using the labeled training dataset, recognizing behavior of the specific employee in response to an input of a motion signal of the specific employee received from the wearable unit, using the trained deep learning model, and output a behavior data of the specific employee; and evaluating employee's work efficiency using the output behavior data.

The evaluating further comprises simulating efficiency for a work solution for the employee using the output behavior data.

The evaluating comprises providing a work solution with optimal efficiency for the specific employee based on a result of the simulating.

The output behavior data includes data on daily behavior, work execution time, and processing time for other works.

The recognizing comprising performing calculations to compare the input motion signal with a previously trained data to decide the behavior data of the specific employee.

The motion signal is collected within a predetermined period of time that varies depending on each company, department, and employee.

The motion signal has a collection cycle set differently for each employee.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual diagram showing a manpower management system according to an embodiment;

FIG. 2 is a block diagram of a manpower management system according to an embodiment;

FIG. 3 is a diagram illustrating a process of training a deep learning model according to an embodiment; and

FIG. 4 is a diagram illustrating the operation of a manpower management system according to an embodiment.

### DETAILED DESCRIPTION

Hereinafter, preferred embodiments of the present invention will be described in detail with reference to the accompanying drawings.

However, the technical spirit of the present invention is not limited to some embodiments described herein but may be implemented in various forms. Within the technical spirit of the present invention, one or more elements may be optionally combined or substituted in the embodiments.

Also, unless expressly defined otherwise, terms (including technical and scientific terms) used herein may be interpreted as having the same meaning as commonly understood by one of ordinary skill in the art to which the present invention belongs. Generally used terms such as terms defined in dictionaries may be interpreted in consideration of the contextual meaning of the related art.

In addition, terms used herein are for explaining the embodiments rather than limiting the present invention.

In this specification, the singular forms are intended to include the plural forms as well, unless the context clearly indicates otherwise. The expression “at least one (or one or more) of A, B, and C” may include one or more of all possible combinations of A, B, and C.

In addition, terms such as first, second, A, B, (a), (b) or the like may be used herein when describing elements of the embodiments of the present invention. These terms are merely used to distinguish one element from another, and the property, order, sequence and the like of a corresponding element are not limited by these terms.

When one element is referred to as being “connected,” “coupled,” or “joined” to another element, the one element may be directly “connected,” “coupled,” or “joined” to the other element directly or through still another element therebetween.

Also, when an element is referred to as being above (over) or below (under) another element, the one element may be in direct contact with the other element, or one or more other elements may be formed or disposed between the two elements. In addition, the term above (on) or below (under) used herein may represent a downward direction in addition to an upward direction with respect to one element.

Hereinafter, exemplary embodiments will be described in detail with reference to the accompanying drawings. The same reference numerals are given to the same or equivalent elements throughout the drawings and redundant descriptions thereof will be omitted.

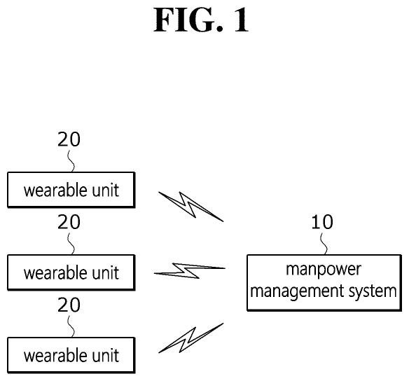

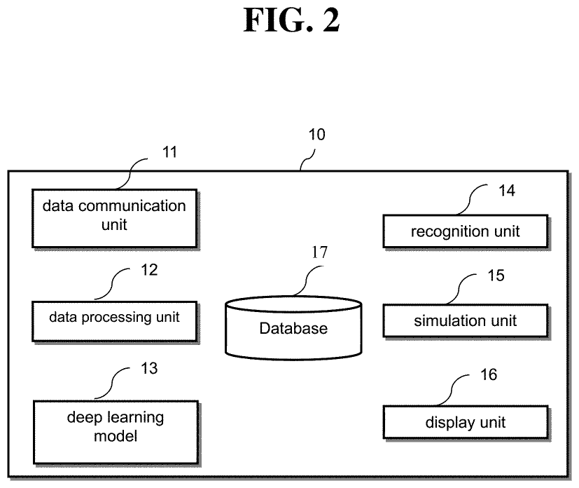

FIG. 1 is a conceptual diagram showing a manpower management system according to an embodiment, and FIG. 2 is a block diagram of a manpower management system according to an embodiment.

Referring to FIGS. 1 and 2, a wearable unit 20 may include various devices that can be worn on a user's body, such as a smart watch, smart band, and activity tracker (vBand). The wearable unit 20 may refer to a personal device that can be worn by and used exclusively for each employee.

After regular shifts, data may be automatically uploaded to a database of the manpower management system 10 and may be used in a system's algorithms for the next analysis. According to an embodiment, the database may be in a form of a datablob of the Azure Internet of Things (IoT) hub.

Alternatively, the wearable unit 20 may be provided with a communication logic and a 6-axis sensor including an acceleration sensor and a gyro sensor and may record motion signals according to six sensor values and store the values in a flash memory.

Alternatively, the wearable unit 20 may include a 3-axis acceleration sensor, a 3-axis gyro sensor, and a 3-axis geomagnetic sensor as a 9-axis motion sensor. However, the motion sensor of the wearable unit 20 of the present invention is not limited to such a case, and various other sensors may be used as long as different pieces of data can be generated and transmitted according to a user's behavior.

When the wearable unit 20 may perform data communication with the manpower management system 10 by the communication logic using a telecommunications technology such as Wireless LAN (WLAN), Wi-Fi, Wireless Broadband (WiBro), World Interoperability for Microwave Access (WiMAX), High Speed Downlink Packet Access (HSDPA), IEEE 802.16, Long Term Evolution (LTE), and Wireless Mobile Broadband Service (WMBS).

Alternatively, the wearable unit 20 may perform data communication with the manpower management system 10 by the communication logic using a short-range communications technology such as Bluetooth, Radio Frequency Identification (RFID), Infrared Data Association (IrDA), Ultra Wideband (UWB), ZigBee, and Near Field Communication (NFC). Alternatively, the wearable unit 20 can communicate with the manpower management system 10 using a wired connection.

In a embodiment, when is the wearable unit 20 is charged and connected to a Wi-Fi network, the collected data may be automatically uploaded to the database for the purpose of additional processing.

The manpower management system 10 according to an embodiment may include a data communication unit 11, a data processing unit 12, a deep learning model 13, a recognition unit 14, a simulation unit 15, a display unit 16, and a database 17.

The data communication unit 11 may receive motion signals from the wearable unit 20 which senses the motions of the corresponding employee. The motion signals may be automatically uploaded to the database 17 when the wearable unit 20 is charged and perform communication with the manpower management system 10. Therefore, the data communication unit 11 may receive the motion signals of the corresponding employee by retrieving the motion signals of the corresponding employee that has been stored in the database 17.

Motion signals may be collected within a predetermined period of time that may vary depending on each company, department, and employee. The wearable unit 20 is worn separately for each individual employee, and the data communication unit 11 may collect motion signals separately for each employee. For example, the motion signals may include identifiable IDs.

Also, a motion signal collection cycle may be set differently for each employee. The data communication unit 11 may set the motion signal collection cycle differently depending on the task characteristics of the employee. For example, in the case of an employee of a company and a department that require a relatively large amount of movement, the data communication unit 11 may set the motion signal collection cycle to be relatively short. Alternatively, in the case of an employee of a company and a department that require relatively little movement, the data communication unit 11 may set the motion signal collection cycle to be relatively long.

The data processing unit 12 may generate a labeled training dataset by labeling the motion signals with corresponding behavior data. The data processing unit 12 may label the collected motion signals under strictly controlled conditions. The labeling may be performed in consideration of research and iterative testing as an optimal way to ensure the recognition performance of a deep learning model.

The data processing unit 12 may collect and label motion signals with corresponding behavior data and then generate an employee-specific labeled training dataset.

Also, the data processing unit 12 may perform a pre-processing operation for simplifying time-series data received from the wearable unit 20. The data processing unit 12 may simplify or formalize information on the motion signals through various pre-processing operations, such as an operation of removing noise from the motion signals or an operation of sampling the motion signals, before the labeling task.

The manpower management system 10 may have a deep learning model 13 which can be trained using the employee-specific labeled training dataset. Motion signals collected from each employee may be learned and processed according to an individual model. Accordingly, the data processing unit 12 may generate a labeled training dataset for the collected motion signals separately for each employee. The employee-specific labeled training dataset may be customized to reduce generality and improve accuracy. Also, unlike using an open source dataset, data collected for a deep learning model may highlight specific data characteristics for an actual task the system needs to achieve.

The data processing unit 12 may generate the employee-specific labeled training dataset by classifying and labeling motion signals collected for each employee according to their IDs. This employee-specific labeled training dataset plays an important role in ensuring the accuracy of an output of the deep learning model, and the actual accuracy of the present invention may be significantly higher than that of the most advanced solution in the art.

The deep learning model 13 may be trained through machine learning using the employee-specific labeled training dataset.

The deep learning model 13 may comprise a neural network for action recognition such as a Temporal Convolutional Network.

The deep learning model 13 may include a computer-readable program. The corresponding program may be stored in a recording medium or storage device that is executable by a computer. A computer processor reads a program stored in a recording medium or storage device, executes a program, that is, a trained model, calculates input information, and outputs a calculation result.

The manpower management system 10 may have a recognition unit 14 for behavior recognition for each employee in order to accurately recognize various employee behaviors in response to an input of a motion signal of the employee received by the data communication unit 11 using the deep learning model 13 that has been trained using the employee-specific labeled training dataset.

The recognition unit 14 may output a behavior data corresponding to the input motion signal using the trained deep learning model.

The recognition unit 14, using the trained deep learning model 13, may perform calculations to compare the input motion signal with a previously trained data to decide the behavior data of the specific employee and may provide an information source for digitizing the employee-specific behavior.

The deep learning model 13 is specialized for each employee. The deep learning models may share the structure of each network layer. However, since training data, that is, the labeled training dataset is specialized for each employee, the parameters of the deep learning models may be completely different from each other and may be customized according to each employee.

The recognition unit 14 may perform a function of recognizing behavior of motion signals collected every day. From the collected result, the manpower management system may record parameters regarding behaviors under a measurement index, e.g., an executed task, an execution time of each task, a processing time of each task, and a process of performing each task, and the like.

The deep learning model 13 may digitize and store an individual employee's behavioral data that has not yet been applied in the prior art.

The simulation unit 15 may evaluate employee's work efficiency using the behavior data output from the recognition unit 14.

The simulation unit 15 may perform accurate prediction by simulating work performance for each work solution for the employee using the behavior data.

The simulation unit 15 may propose a work solution with optimal efficiency for each employee based on the result of the simulation.

The simulation unit 15 may simulate the implementation of each solution for each employee by utilizing the behavior data of the corresponding employee. The simulation unit 15 may analyze a daily behavior, a work execution time, and a processing time for other behaviors of each employee through employee-specific behavior data and thus may evaluate work efficiency for a work solution for each employee.

For example, the simulation unit 15 may evaluate that work efficiency for a corresponding solution decreases as the work execution time increases. Alternatively, the simulation unit 15 may evaluate that work efficiency for a corresponding solution decreases as the processing time for other behaviors increases. Alternatively, the simulation unit 15 may evaluate that work efficiency for a corresponding solution increases as the number of complex executed tasks is high in a predetermined period of time.

The simulation unit 15 may provide an optimal solution recommended to an administrator on the basis of a result of the simulation. For example, the simulation unit 15 may provide an administrator with a solution analyzed as having the highest work efficiency as an optimal solution for a corresponding employee.

The display unit 16 may display motion signals collected for each employee, employee-specific behavior data, and employee-specific work efficiency for each solution on a dashboard.

The display unit 16 may include at least one of a liquid crystal display (LCD), a thin film transistor liquid crystal display (TFT LCD), an organic light-emitting diode (OLED), and a flexible display, a three-dimensional (3D) display, and an e-ink display.

Also, the display unit 16 may output various user interfaces or graphic user interfaces to a screen.

Also, the display unit 16 may receive various types of input data in order to set the dashboard and control operation of the manpower management system. The display unit 16 may include a keypad, a dome switch, a touchpad, a jog wheel, a jog switch, or the like. The display unit 16 and the touchpad may be configured as a touch screen by forming a mutual layer structure.

The database 17 may include at least one storage device among a flash memory type memory, a hard disk type memory, a multimedia card micro type memory, a card type memory (e.g., an SD or XD memory), a magnetic memory, a magnetic disk, an optical disc, a random access memory (RAM), a static random access memory (SRAM), a read-only memory (ROM), an electrically erasable programmable read-only memory (EEPROM), and a programmable read-only memory (PROM). Also, the manpower management system may operate a web storage that performs a storage function of the database 17 on the Internet or may operate in association with a web storage.

The database 17 may store information such as motion signals, behavior data, work efficiency for solutions, and the like.

Also, the database 17 may store data, programs, and the like which are required for the manpower management system to operate.

Also, the database 17 may store various user interfaces (UIs) or graphic user interfaces (GUIs).

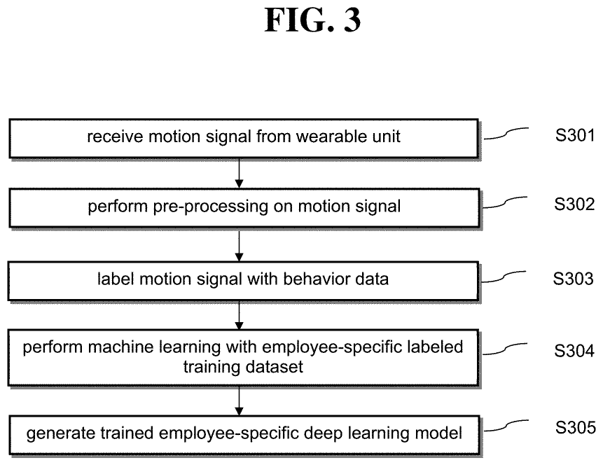

FIG. 3 is a flowchart illustrating a process of training a deep learning model according to an embodiment.

Referring to FIG. 3, in step S301, a data communication unit may receive motion signals from a wearable unit worn by each employee to sense corresponding employee's motions. Motion signals may be collected within a predetermined period of time that may vary depending on each company, department, and employee. The wearable unit is worn by each employee individually, and the data communication unit may collect motion signals separately for each employee. For example, the motion signals may include identifiable IDs. Also, a motion signal collection cycle may be set differently for each employee. The data communication unit may set a motion signal collection cycle differently depending on the task characteristics of the employee. For example, in the case of an employee of a company and a department that require a relatively large amount of movement, the data communication unit may set the motion signal collection cycle to be relatively short. Alternatively, in the case of an employee of a company and a department that require relatively little movement, the data communication unit may set the motion signal collection cycle to be relatively long.

In step S302, a data processing unit may perform a pre-processing operation for simplifying time-series data received from the wearable unit. The data processing unit may simplify or formalize information on the motion signals through various pre-processing operations, such as an operation of removing noise from the motion signals or an operation of sampling the motion signals.

In step 303, the data processing unit may generate a labeled training dataset by labeling the motion signals with corresponding behavior data. The data processing unit may label the collected motion signals under strictly controlled conditions. The labeling may be performed in consideration of research and iterative testing as an optimal way to ensure the recognition performance of a deep learning model. In this case, the data processing unit may collect and label motion signals and then generate an employee-specific labeled training dataset.

In step 304, a deep learning model may be trained through machine learning using the labeled training dataset.

In step 305, an employee-specific deep learning model that has been trained may be generated.

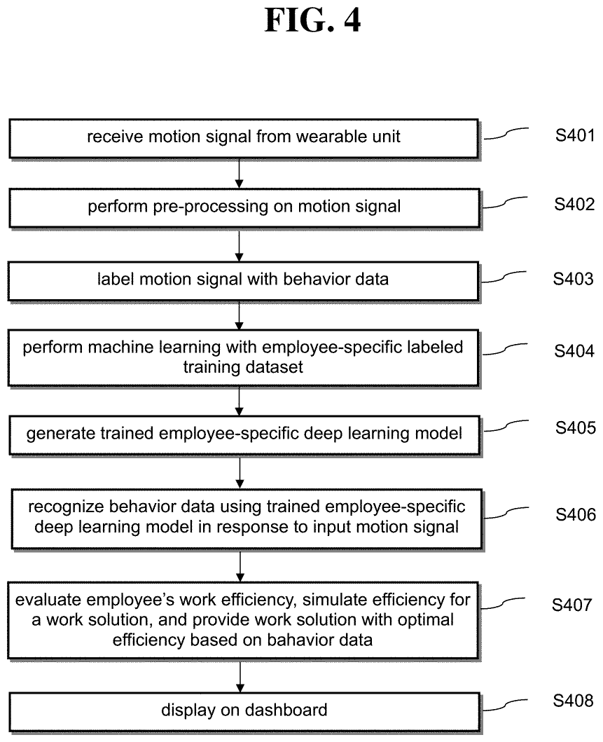

FIG. 4 is a flowchart illustrating the operation of a manpower management system according to an embodiment.

Referring to FIG. 4, in step 401, a data communication unit receives motion signals from a wearable unit worn by each employee to sense corresponding employee's motions. Motion signals may be collected within a predetermined period of time that may vary depending on each company, department, and employee. The wearable unit is worn by each employee individually, and the data communication unit may collect motion signals separately for each employee. For example, the motion signals may include identifiable IDs. Also, a motion signal collection cycle may be set differently for each employee. The data communication unit may set a motion signal collection cycle differently depending on the task characteristics of the employee. For example, in the case of an employee of a company and a department that require a relatively large amount of movement, the data communication unit may set the motion signal collection cycle to be relatively short. Alternatively, in the case of an employee of a company and a department that require relatively little movement, the data communication unit may set the motion signal collection cycle to be relatively long.

Next, in step 402, a data processing unit may perform a pre-processing operation for simplifying time-series data received from the wearable unit. The data processing unit may simplify or formalize information on the motion signals through various pre-processing operations, such as an operation of removing noise from the motion signals or an operation of sampling the motion signals.

In step 403, the data processing unit may generate a labeled training dataset by labeling the motion signals with corresponding behavior data. The data processing unit may label the collected motion signals under strictly controlled conditions. The labeling may be performed in consideration of research and iterative testing as an optimal way to ensure the recognition performance of a deep learning model. In this case, the data processing unit may collect and label motion signals and then generate an employee-specific labeled training dataset.

Next, in step 404, a learning model may be trained through machine learning using the labeled training dataset. An employee-specific deep learning model that has been trained may be generated in step 405.

In step 406, a recognition unit 14 may perform behavior recognition for each employee in order to accurately recognize various employee behaviors in response to an input of a motion signal of the employee received by the data communication unit using the deep learning model that has been trained using the employee-specific labeled training dataset. The recognition unit may output a behavior data corresponding to the input motion signal using the trained deep learning model.

Next, in step 407, the simulation unit may evaluate employee's work efficiency using the behavior data output from the recognition unit. The simulation unit may simulate the work performance of each solution for each employee's performance by utilizing the behavior data of the corresponding employee. The simulation unit may propose a work solution with optimal efficiency for each employee based on the result of the simulation. For example, the simulation unit may analyze a daily behavior, a work execution time, and a processing time for other behaviors of each employee through employee-specific behavior data based on a deep learning model and thus may evaluate work efficiency for a work solution for each employee.

Next, in step 408, the display unit may display motion signals collected for each employee, employee-specific behavior data, and employee-specific work efficiency for each solution on a dashboard.

According to the manpower management system of the present invention, it is possible to improve the work efficiency of employees. According to some implementations, the manpower management system may improve 25% work efficiency of employees.

Also, it is possible to provide guidelines for manpower arrangement in companies, schools, organizations, etc.

The term “unit” used herein refers to a hardware element such as a field-programmable gate array (FPGA) or application-specific integrated circuit (ASIC) and performs a certain role. However, the term “unit” is not limited to software or hardware. A “unit” may be configured to be in an addressable storage medium or to execute one or more processors. Therefore, for example, the “unit” includes elements, such as software elements, object-oriented elements, class elements, and task elements, processes, functions, attributes, procedures, subroutines, segments of a program code, drivers, firmware, a microcode, a circuit, data, a database (DB), data structures, tables, arrays, and parameters. Functions provided in elements and “units” may be combined into a smaller number of elements and “units” or may be further separated into additional elements and “units.” Additionally, the elements and “units” may be implemented to execute one or more CPUs in a device or a security multimedia card.

While the present invention has been described with reference to exemplary embodiments, it will be understood by those skilled in the art that variations and modifications of the invention may be made without departing from the spirit and scope of the invention as defined by the appended claims.

What is claimed is:

1. A manpower management system comprising:
a data communication unit configured to receive motion signals from a wearable unit worn by a specific employee to sense motions of the specific employee;
a data processing unit configured to label the motion signals with behavior data to generate a labeled training dataset for the specific employee;
a deep learning model for the specific employee configured to be trained through machine learning using the labeled training dataset,
a recognition unit configured to recognize behavior of the specific employee in response to an input of a motion signal of the specific employee received by the data communication unit, using the trained deep learning model, and output a behavior data of the specific employee; and
a simulation unit configured to evaluate employee's work efficiency using the output behavior data.

2. The manpower management system of claim 1, wherein the simulation unit is further configured to simulate efficiency for a work solution for the specific employee using the output behavior data.

3. The manpower management system of claim 2, wherein the simulation unit is configured to provide a work solution with optimal efficiency for the specific employee based on a result of the simulation.

4. The manpower management system of claim 1, wherein the output behavior data includes data on daily behavior, work execution time, and processing time for other works.

5. The manpower management system of claim 1, wherein the recognition unit configured to perform calculations to compare the input motion signal with a previously trained data to decide the behavior data of the specific employee.

6. The manpower management system of claim 1, wherein the motion signal is collected within a predetermined period of time that varies depending on each company, department, and employee.

7. The manpower management system of claim 6, wherein the motion signal has a collection cycle set differently for each employee.

8. A manpower management method comprising:
receiving motion signals from a wearable unit worn by a specific employee to sense motions of the specific employee;
labeling the motion signals with behavior data to generate a labeled training dataset for the specific employee;
training a deep learning model for the employee using the labeled training dataset,
recognizing behavior of the specific employee in response to an input of a motion signal of the specific employee received from the wearable unit, using the trained deep learning model, and output a behavior data of the specific employee; and
evaluating employee's work efficiency using the output behavior data.

9. The manpower management method of claim 8, wherein the evaluating further comprises simulating efficiency for a work solution for the employee using the output behavior data.

10. The manpower management method of claim 9, wherein the evaluating comprises providing a work solution with optimal efficiency for the specific employee based on a result of the simulating.

11. The manpower management method of claim 8, wherein the output behavior data includes data on daily behavior, work execution time, and processing time for other works.

12. The manpower management method of claim 8, wherein the recognizing comprising performing calculations to compare the input motion signal with a previously trained data to decide the behavior data of the specific employee.

13. The manpower management method of claim 8, wherein the motion signal is collected within a predetermined period of time that varies depending on each company, department, and employee.

14. The manpower management method of claim 8, wherein the motion signal has a collection cycle set differently for each employee.
